(19) United States
(12) Patent Application Publication
(10) Pub. No.: US 2011/0219654 A1
(43) Pub. Date: Sep. 15, 2011

(54) DISPLAY MEANS

(75) Inventor: Mats Gunnar Henrik KROON, Anderstorp (SE)

(73) Assignee: Expand International AB, Johanneshov (SE)

(21) Appl. No.: 13/047,117

(22) Filed: Mar. 14, 2011

Related U.S. Application Data
(60) Provisional application No. 61/313,829, filed on Mar. 15, 2010.

(51) Int. Cl. G09F 15/00

(52) U.S. Cl. 40/607.04

(57) ABSTRACT

The present invention relates to a display means comprising a stand adapted to secure a screen. The stand comprises a first part which supports against an underlying supportive surface and comprises a bobbin enclosed in a cavity in the first part, wherein the screen can be wounded onto and withdrawn from the bobbin. The stand also comprises a pole means, and a coupling means arranged at a first end of the pole means, and operable to secure the screen when it is at least partly withdrawn from the bobbin. The first part is provided with a recess operable to receive a part of the pole means. The stand also comprises an adjustment means arranged at the first part, and operable to adjust the pole means, and consequently the screen in relation to the first part.

### RELATED APPLICATION DATA

This application claims priority under 35 U.S.C. §119(e) to U.S. Provisional Application No. 61/313,829 filed on Mar. 15, 2010, the entire contents of which are incorporated herein by reference

### FIELD

The present disclosure relates to a display means with adjustment possibility for the screen.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

The U.S. Pat. No. 4,700,498 relates to a portable display apparatus, although not a so called roll-up display. The display area can be tilted forward or rearward by adjusting the length of two vertical support members 28. This is made possible because each support member 28 is telescopic.

The patent document EP 0 969 442 A1 relates to a support which comprises a number of pieces which can be attached to each other and is designed for holding one or two advertising posters by the upper and lower ends, keeping them in substantially vertical position. This support includes a supporting base composed of two sides attached to each other by means of detachable crosspieces; each one the sides has tensioners to act upon the lower ends of one or two posters, intermediate seats for mounting flexible structures, which are independent and finished at the top in two pieces for hanging the posters, means for fitting one or more tensioning cables which act upon the pieces, keeping the structures flexed and ensuring that the pieces are held at the desired height, in function of the height of the posters to be displayed. The structures are composed of a variable number of sections, of equal length, which are joined by intermediate connecting pieces, while the height of said structures can be adjusted by attachment of a greater or lesser number of sections. It is pointed out that this support is not a so called roll-up display.

The document DE 299 13 949 U1 relates to a display means, although not a so called roll-up display. The display means is provided with three feet, which are adjustable in order to compensate for a floor which is uneven.

The patent document US 2007/0002440 A1 relates to a portable screen assembly which can be readily transported together with a projector and is easy to handle and simple in construction. The portable screen assembly includes a casing having an opening extending in a longitudinal direction on the upper surface thereof and formed by a first and second case members that extend in the longitudinal direction and are separable from each other, a spring-biased roll rotatable mounted to the casing, a screen wound around the spring-biased roll in storage and pulled out from the opening in use, a top bar fixed to one end of the screen and used also as a cover body to close the opening in storage, and an extendable column having one end erectable pivoted at a center part of the side face of the casing and, in an erected state, holding the pulled out screen in a stretched state.

Generally, the appearance of a graphic presentation is best if the screen or the printed panel is positioned in a vertical position. One problem arises when the product is put on a floor that is uneven. Another problem arises when the height of the telescopic pole is increased, making the screen/panel tilt forward as the center of gravity changes. Attaching a spotlight at the top of the display means will also make the screen/panel tilt forward due to the fact that the centre of gravity changes.

Consequently, there is a need for adjustment possibilities for the screen. The above mentioned solutions have adjustment possibilities, but they suffer from a lot of disadvantages. They are either not suited for so called roll-up displays, and/or they are to complicated, and/or are not easy to handle.

### SUMMARY

The above mentioned problems are solved with a display means according to Claim 1. The display means comprises a stand adapted to secure a screen, wherein the stand comprises a first part which supports against an underlying supportive surface and comprises a bobbin enclosed in a cavity in the first part. The screen can be wounded onto and withdrawn from the bobbin. The stand also comprises a pole means, and a coupling means arranged at a first end of the pole means and operable to secure the screen when it is at least partly withdrawn from the bobbin. The first part is provided with a recess operable to receive a part of the pole means comprising a second end of the pole means, or to receive a lever means partly arranged in the pole means. Furthermore, the stand also comprises an adjustment means arranged at the first part, and operable to directly adjust the pole means, or indirectly adjust the pole means via the lever means, and consequently the screen in relation to the first part.

A main advantage with this solution is that it is adapted for a so called roll-up display. Furthermore, the adjustment of the screen can be done with one hand, in one simple operation. A further advantage is that it is possible to adjust the screen without moving the display means, implying that it is possible to see the outcome of the adjustment directly.

A further advantage in this context is achieved if the stand also comprises a pole cup means arranged in the first part, and adapted to receive the pole means.

Furthermore, it is an advantage in this context if the pole cup means is provided with an aperture.

A further advantage in this context is achieved if the first part is provided with a through hole having an internal thread, and if the adjustment means is in the form of a rod having an external thread, and an operating means connected to the rod. The internal and external threads are mating each other, and the rod is abutting the pole cup means. The operating means is operable to being turned, adjusting the pole cup means, the pole means, and the screen.

According to another embodiment it is an advantage if the first part is provided with a through hole having an internal thread, wherein the through hole and the aperture at least partly are coinciding, and if the adjustment means is in the form of a rod having an external thread, and an operating means connected to the rod. The internal and external threads are mating each other, and the rod is abutting the pole means, or the lever means. The operating means is operable to being turned, directly adjusting the pole means, or indirectly adjusting the pole means via the lever means, and the screen.

A further advantage in this context is achieved if the first part is provided with a through aperture adapted to receive the adjustment means, and if the adjustment means is in the form of a cam disc means, and a cam shaft. The cam shaft is connected to the first part, and arranged through the cam disc means in such a way that the cam disc means is operable to be at least partly rotated around the cam shaft. The cam disc means comprises a cam surface at least partly abutting the pole cup means, and an operating part protruding from the first part. The operating part is operable to being operated, at least partly rotating the cam disc means around the cam shaft, adjusting the pole cup means, the pole means, and the screen.

According to another embodiment it is an advantage if the first part is provided with a through aperture at least partly coinciding with the aperture, both adapted to the adjustment means, and if the adjustment means is in the form of a cam disc means, and a cam shaft. The cam shaft is connected to the first part, and arranged through the cam disc means in such a way that the cam disc means is operable to be at least partly rotated around the cam shaft. The cam disc means comprises a cam surface at least partly abutting the pole means, or the lever means, and an operating part protruding from the first part. The operating part is operable to being operated, at least partly rotating the cam disc means around the cam shaft, directly adjusting the pole means, or indirectly adjusting the pole means via the lever means, and the screen.

Furthermore, it is an advantage in this context if the cam surface is mirror symmetrical in relation to a central plane parallel to the length axis of the cam disc means.

According to another embodiment it is an advantage if the cam surface is mirror asymmetrical in relation to a central plane parallel to the length axis of the cam disc means.

A further advantage in this context is achieved if the cam shaft is arranged along the central plane parallel to the length axis of the cam disc means.

According to another embodiment it is an advantage if the cam shaft is arranged outside the central plane parallel to the length axis of the cam disc means.

It will be noted that the term “comprises/comprising” as used in this description is intended to denote the presence of a given characteristic, step, or component, without excluding the presence of one or more other characteristic, features, integers, steps, components, or groups thereof.

It is to be understood that both the foregoing general description and the following detailed description are exemplary and explanatory and are intended to provide further explanation of the invention as claimed

### BRIEF DESCRIPTION OF THE DRAWINGS

Embodiments of the invention will now be described with a reference to the accompanying drawings, in which:

FIG. 1 illustrates assembly sequences A-G, applicable to a known display means.

FIG. 2 discloses side views of a display means, illustrating one of the problems which the present invention solves.

FIG. 3 discloses a first embodiment of the display means according to the present invention, partly in a side view and partly in a cross section view.

FIG. 4 discloses the first embodiment of the display means according to the present invention, partly in a side view and partly in a cross section view.

FIG. 5 discloses a more detailed view of the first embodiment of the display means according to the present invention.

FIG. 6 discloses a second embodiment of the display means according to the present invention, partly in a cross section view and partly in a top view.

FIG. 7 is a cross section view of a part of a third embodiment of the display means according to the present invention.

FIG. 8 is a top view of a part of a fourth embodiment of the display means according to the present invention.

FIG. 9 is a cross section view of a part of a fifth embodiment of the display means according to the present invention.

FIG. 10 is a cross section view of a part of a sixth embodiment of the display means according to the present invention.

### DETAILED DESCRIPTION

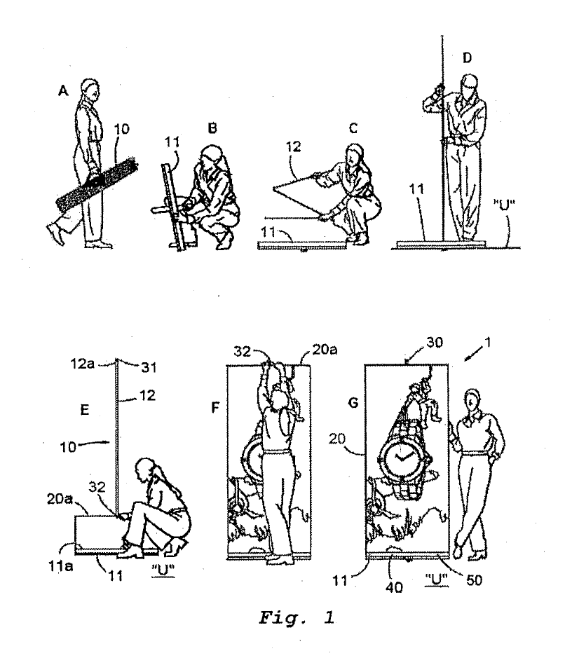

In FIG. 1 there is disclosed a more or less complete assembly sequence with the aid of individual assembly steps referenced A-G of a display means 1, this assembly sequence or erection sequence also being applicable to the display means 1 according to the present invention.

According to step A, the display means 1 comprises a stand 10, which in a fully erected state (steps F, G) firmly supports a screen 20, wherein the stand 10 comprises a first part 11 which supports against an underlying supportive surface U (step D), and further includes a foldable part 12 which, when the stand 10 is erected, extends upwardly from the first part 11.

One upwardly extending end part 12a of the second part 12 (step E) has a first coupling element 31 included in a two-part coupling arrangement 30, wherewith the other coupling element 32 of the coupling arrangement is joined to the screen 20 either directly or indirectly, and orientated in connection with the upper edge part 20a of the screen 20.

The screen 20 can be wound onto and unwound from a bobbin 40 enclosed in a cavity (not shown) located in the first part 11, wherein the bobbin 40 can be actuated by a spring arrangement 50 that includes an associated spring unit.

The spring arrangement 50 is designed to act on the screen 20 with a decreasing force during a screen wind-up phase (the steps from F to E) with the aid of a spring unit consisting of helically twisted or wound metal wire, wherewith the screen 20 is acted upon at an increasing force during an unwinding phase (the steps from E to F).

The spring arrangement 50 is also adapted to act on the screen 20 with a chosen initial power when the screen 20 has been fully wound around the bobbin 40 (in accordance with the step D).

The first part 11 includes a slot 11a through which the screen 20 passes as to be unwound from or wound onto the bobbin 40 present in the cavity.

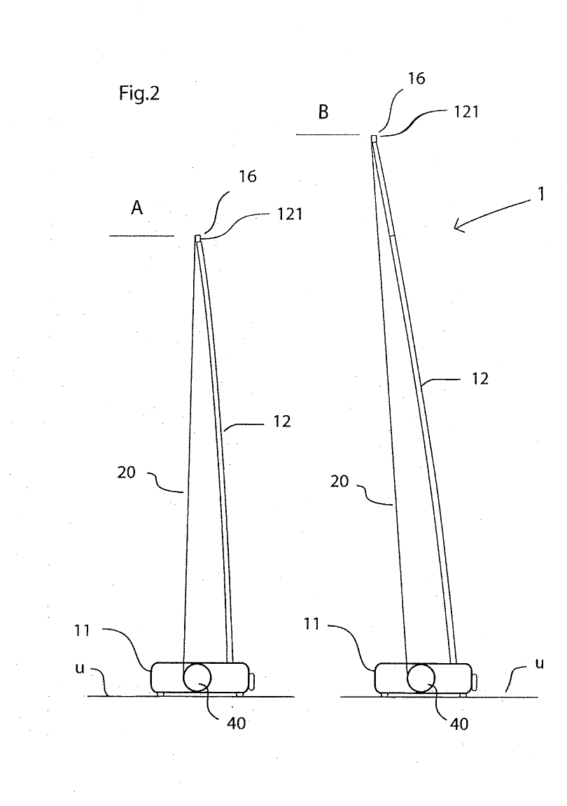

In FIG. 2 there are disclosed two side views of a display means 1, illustrating one of the problems which the present invention solves. As is apparent in FIG. 2, the display means 1 comprises a stand adapted to secure a screen 20, wherein the stand comprises a first part 11 which supports against an underlying supportive surface (u) and comprises a bobbin 40 enclosed in a cavity in the first part 11. The screen 20 can be wounded onto and withdrawn from the bobbin 40. As also is apparent in FIG. 2, the stand also comprises a pole means 12, and a coupling means 16 arranged at a first end 121 of the pole means 12, and operable to secure the screen 20 when it is at least partly withdrawn from the bobbin 40.

When the display means 1 is arranged at the height A it is apparent that the screen 20 is almost vertical, which is desirable. When on the other hand the height of the display means 1 is increased to level B it is apparent that the screen 20 is tilting forward as the centre of gravity changes. The same applies if a spotlight is attached at the coupling means 16 in order to illuminate the screen 20.

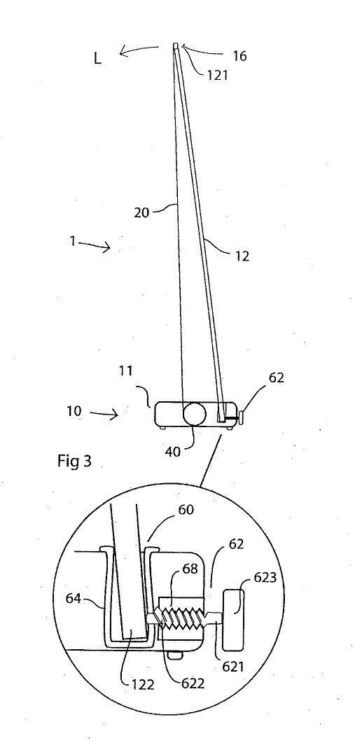

In FIG. 3 there is disclosed a first embodiment of the display means 1 according to the present invention, partly in a side view and partly in a cross section view. Besides the elements disclosed in FIG. 2 and designated with the same reference signs, the stand 10 also comprises an adjustment means 62 arranged at the first part 11. The adjustment means 62 is operable to directly adjust the pole means 12, and consequently the screen 20 in relation to the first part 11. In the lower part of FIG. 3, the cross section view, it is apparent that the stand 10 also comprises a pole cup means 64 arranged in the first part 11, and adapted to receive the pole means 12, here disclosed in the form of its second end 122.

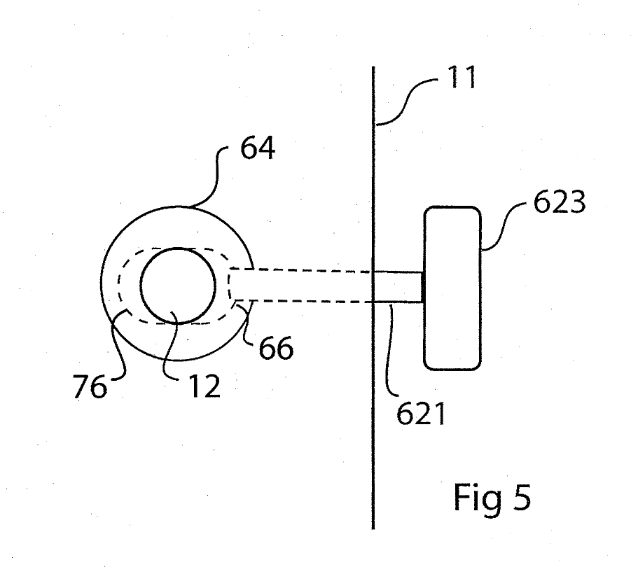

In this particular embodiment, the first part 11 is provided with a through hole having an internal thread 68, and the pole cup means 64 has an aperture (66, see FIG. 5). The through hole and the aperture 66 are at least partly coinciding, as is apparent in the lower part of FIG. 3. The adjustment means 62 is in the form of a rod 621 having an external thread 622, and an operating means 623 connected to the rod 621. The internal and external threads 68, 622 are mating each other, implying that it is possible to screw in or out the rod 621, thereby adjusting the pole means 12, and the screen 20, by turning the operating means 623 in either direction. As is apparent in the lower part of FIG. 3, the rod 621 is abutting the pole means 12, here disclosed in the form of the second end 122 of the pole means 12. It is also pointed out that in FIG. 3 the pole means 12 is situated in its most left position, indicated with the arrow designated L in the side view.

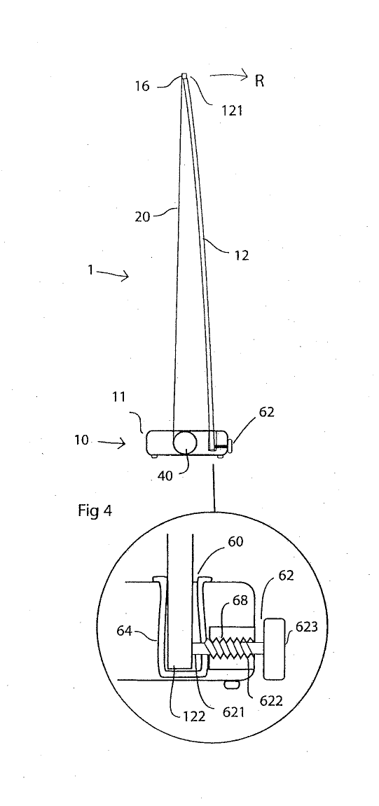

In FIG. 4 there is also disclosed the first embodiment of the display means 1 according to the present invention. The difference in relation to FIG. 3 is that the pole means 12 is situated in its most right position, indicated with the arrow designated R in the side view.

In FIG. 5 there is disclosed a detailed view of the display means 1 according to the present invention. This is the embodiment with a pole cup means 64 provided with an aperture 66, in order to let the rod 621 pass there through. The reference sign 76 denotes the space available for the pole means 12 in the pole cup means 64.

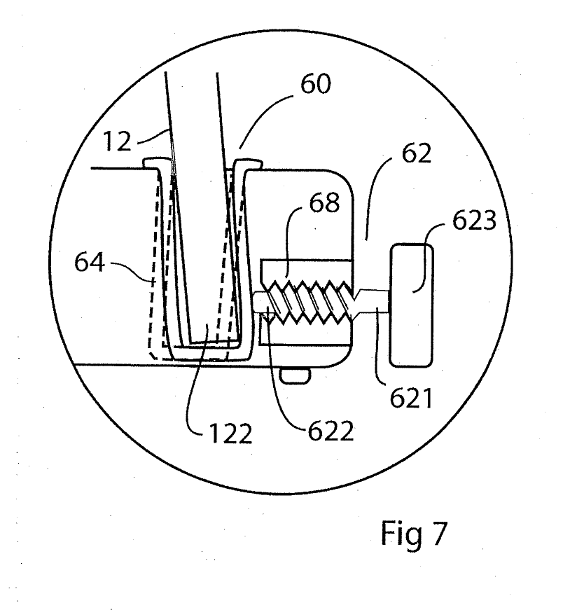

In FIG. 7 there is disclosed a cross section view of a part of a third embodiment of the display means 1 according to the present invention. In this embodiment the adjustment means 62 also comprises the rod 621 having an external thread 622, and an operating means 623 connected to the rod 621. Furthermore, the first part 11 is provided with a through hole having an internal thread 68. The difference with this embodiment in comparison to the first embodiment is that the pole cup means 64 has no aperture. This means that the rod 621 is abutting the pole cup means 64, instead of the pole means 12. When the operating means 623 is being turned in either direction, the pole cup means 64, the pole means 12, and the screen 20 being adjusted. As also is disclosed in FIG. 7 are the end positions of the pole cup means 64, disclosed on the one hand with solid line, and on the other hand with broken line.

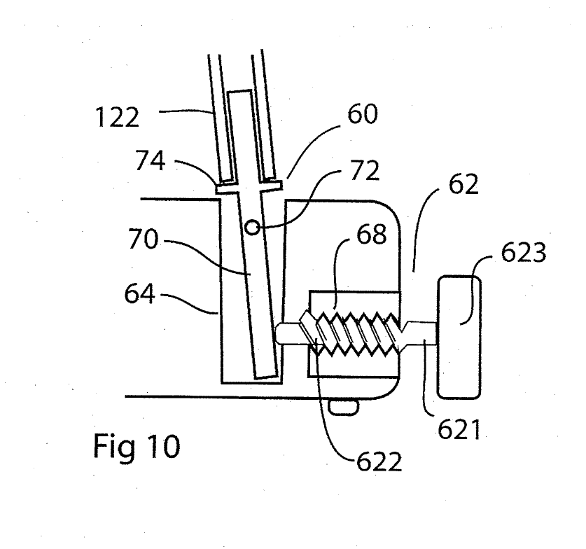

In FIG. 10 there is disclosed a cross section view of a part of a sixth embodiment of the display means 1 according to the present invention. In this particular embodiment, the pole means 12, here disclosed in the form of the second end 122, is not placed in the pole cup means 64. Instead, a lever means 70 is on the one hand placed in the pole cup means 64, and on the other hand arranged with another end in the pole means 12 (122). Furthermore, the lever means 70 also comprises a pole stop means 74 operable to stop the moving of the pole means 12 in the downward direction. The lever means 70 can be pivoted around a lever shaft 72, arranged in the pole cup means 64, and attached to the first part 11 (not disclosed). As is apparent in FIG. 10 the rod 621 is abutting the lever means 70. When turning the operating means 623, the pole means 12 is being adjusted indirectly via the lever means 70, and consequently the screen 20 (not disclosed).

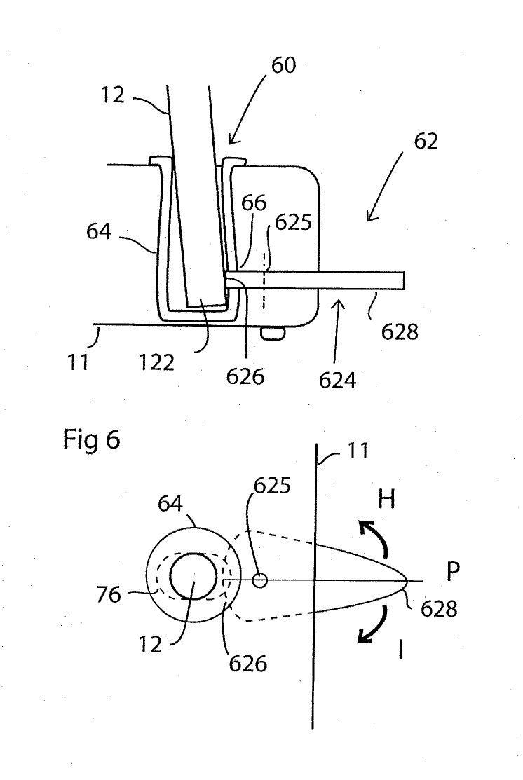

In FIG. 6 there is disclosed a second embodiment of the display means 1 according to the present invention, partly in a cross section view and partly in a top view. In this particular embodiment, the stand 10 comprises a pole cup means 64 arranged in the first part 11, and adapted to receive the pole means 12 in the form of the second end 122 of the pole means 12. As is apparent in FIG. 6, the pole cup means 64 is provided with an aperture 66. Furthermore, the first part 11 is provided with a through aperture at least partly coinciding with the aperture 66 in the pole cup means 64, both apertures adapted to receive the adjustment means 62. In this particular embodiment the adjustment means 62 is in the form of a cam disc means 624, and a cam shaft 625, wherein the cam shaft 625 is connected to the first part 11, and arranged through the cam disc means 624 in such a way that the cam disc means 624 at least partly can be rotated around the cam shaft 625. The cam disc means 624 can be divided in two different parts regarding functionality, namely a cam surface 626 at least partly abutting the pole means 12 (122), and an operating part 628 protruding from the first part 11. When rotating the cam disc means 624 by operating the operating part 628 in either direction H, or I, the pole means 12, and the screen 20 will be adjusted. As is apparent in the lower part of FIG. 6, the cam surface 626 is mirror symmetrical in relation to a central plane P parallel to the length axis of the cam disc means 624. Furthermore, the cam shaft 625 is arranged along the central plane P parallel to the length axis of the cam disc means 624.

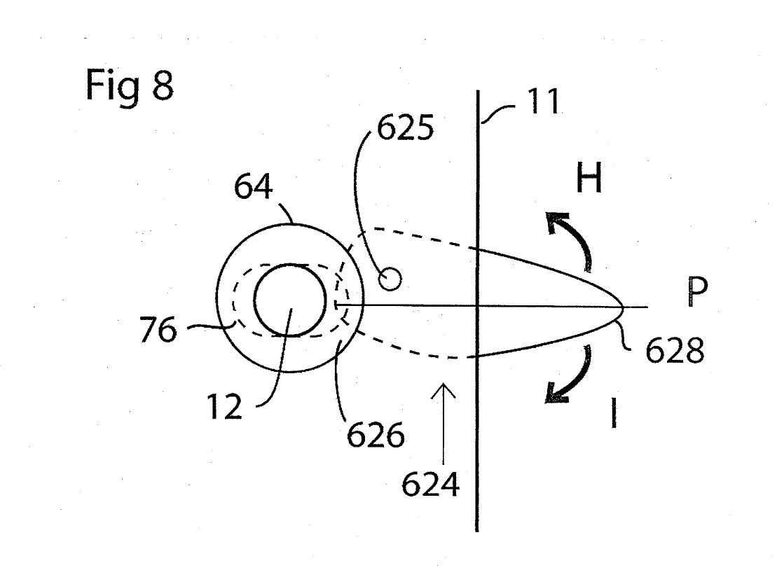

In FIG. 8 there is disclosed a top view of a part of a fourth embodiment of the display means 1 according to the present invention. This embodiment is similar to the embodiment disclosed in FIG. 6. But there are some differences. As is apparent in FIG. 8 the cam surface 626 is mirror asymmetrical in relation to the central plane P parallel to the length axis of the cam disc means 624. Furthermore, the cam shaft 625 is arranged outside of the central plane P parallel to the length axis of the cam disc means 624. This embodiment works in the same way as the embodiment disclosed in FIG. 6 does.

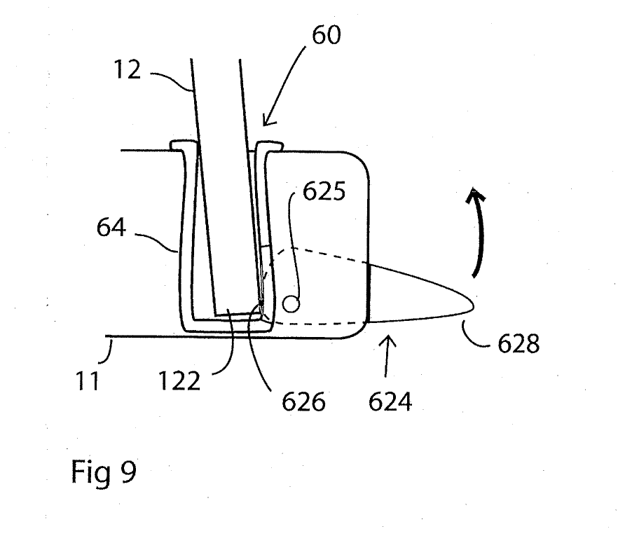

In FIG. 9 there is disclosed a cross section view of a part of a fifth embodiment of the display means 1 according to the present invention. In this particular embodiment, the adjustment means 62 is different. The adjustment means 62 is in the form of a cam disc means 624, and a cam shaft 625, wherein the cam shaft 625 is connected to the first part 11, and arranged through the cam disc means 624 in such a way the cam disc means 624 at least partly can be rotated around the cam shaft 625. The main difference is that both the cam disc means 624, and the cam shaft 625 are rotated 90 degrees in relation to the embodiment disclosed in FIG. 6. Also in this case the cam disc means 624 can be divided in a cam surface 626, abutting the pole means 12 (122), and an operating means 628 protruding from the first part 11. When the operating means 628 is moved in the direction of the disclosed arrow, the pole means 12, and the screen 20 will be adjusted.

It is pointed out that the above disclosed embodiments can at least partly be combined in many different ways. E.g. can the solution with a cam disc means 624 be combined with a pole cup means 64 without an aperture.

When the adjustment means 62 is in the form of a cam disc means 624, and a cam shaft 625, it is pointed out that they can be oriented in any angle between the extremes disclosed in FIG. 6 and FIG. 9.

When having an embodiment with a cam disc means 624, and a cam shaft 625, it is possible to have a locking device (not disclosed) to have the cam disc means 624 in the desired position. This locking device can be achieved by having a surface with a high friction coefficient on the operating means 628 being in contact with the corresponding surfaces in the first part 11. The friction coefficient will be chosen so it is possible to move the cam disc means 624 in order to adjust the pole means 12, but as soon as the operating means 628 is released the friction will be high enough to hold it in place.

The invention is not limited to the described embodiments. It will be evident for those skilled in the art that many different modifications are feasible within the scope of the following Claims.

What is claimed is:

1. A display means comprising a stand adapted to secure a screen, wherein said stand comprises a first part which supports against an underlying supportive surface and comprises a bobbin enclosed in a cavity in said first part, wherein said screen can be wounded onto and withdrawn from said bobbin, wherein said stand also comprises a pole means, and a coupling means arranged at a first end of said pole means and operable to secure said screen when it is at least partly withdrawn from said bobbin, wherein said first part is provided with a recess operable to receive a part of said pole means comprising a second end of said pole means, or to receive a lever means partly arranged in said pole means, and in that said stand also comprises an adjustment means arranged at said first part and operable to directly adjust said pole means, or indirectly adjust said pole means via said lever means, and consequently said screen in relation to said first part.

2. A display means according to claim 1, wherein said stand also comprises a pole cup means arranged in said first part, and adapted to receive said pole means.

3. A display means according to claim 2, wherein said pole cup means is provided with an aperture.

4. A display means according to claim 2, wherein said first part is provided with a through hole having an internal thread, and in that said adjustment means is in the form of a rod having an external thread, and an operating means connected to said rod, wherein said internal and external threads are mating each other, and in that said rod is abutting said pole cup means, wherein said operating means is operable to being turned, adjusting said pole cup means, said pole means, and said screen.

5. A display means according to claim 3, wherein said first part is provided with a through hole having an internal thread, wherein said through hole and said aperture at least partly are coinciding, and in that said adjustment means is in the form of a rod having an external thread, and an operating means connected to said rod, wherein said internal and external threads are mating each other, and in that said rod is abutting said pole means, or said lever means, wherein said operating means is operable to being turned, directly adjusting said pole means, or indirectly adjusting said pole means via said lever means, and said screen.

6. A display means according to claim 2, wherein said first part is provided with a through aperture adapted to receive said adjustment means, and in that said adjustment means is in the form of a cam disc means, and a cam shaft, wherein said cam shaft is connected to said first part, and arranged through said cam disc means in such a way that said cam disc means is operable to be at least partly rotated around said cam shaft, and in that said cam disc means comprises a cam surface at least partly abutting said pole cup means, and an operating part protruding from said first part, wherein said operating part is operable to being operated, at least partly rotating said cam disc means around said cam shaft, adjusting said pole cup means, said pole means, and said screen.

7. A display means according to claim 3, wherein said first part is provided with a through aperture at least partly coinciding with said aperture, both adapted to receive said adjustment means, and in that said adjustment means is in the form of a cam disc means, and a cam shaft, wherein said cam shaft is connected to said first part, and arranged through said cam disc means in such a way that said cam disc means is operable to be at least partly rotated around said cam shaft, and in that said cam disc means comprises a cam surface at least partly abutting said pole means, or said lever means, and an operating part protruding from said first part, wherein said operating part is operable to being operated, at least partly rotating said cam disc means around said cam shaft, directly adjusting said pole means, or indirectly adjusting said pole means via said lever means, and said screen.

8. A display means according to claim 6, wherein in that said cam surface is mirror symmetrical in relation to a central plane parallel to the length axis of said cam disc means.

9. A display means according to claim 6, wherein said cam surface is mirror asymmetrical in relation to a central plane parallel to the length axis of said cam disc means.

10. A display means according to claim 8, wherein said cam shaft is arranged along said central plane parallel to the length axis of said cam disc means.

11. A display means according to claim 8, wherein said cam shaft is arranged outside said central plane parallel to the length axis of said cam disc means.
